(19) United States
(12) Patent Application Publication
(10) Pub. No.: US 2025/0251949 A1
(43) Pub. Date: Aug. 7, 2025

(54) INFORMATION PROCESSING SYSTEM, INFORMATION PROCESSING METHOD, AND NON- TRANSITORY COMPUTER-READABLE MEDIUM

(71) Applicants: NEC Corporation, Tokyo (JP); NATIONAL UNIVERSITY CORPORATION HOKKAIDO UNIVERSITY, Sapporo-shi (JP)

(72) Inventors: Kosuke AKIMOTO, Tokyo (JP); Masafumi Oyamada, Tokyo (JP); Kunihiko Sadamasa, Tokyo (JP); Masaharu Yoshioka, Hokkaido (JP); Ryoma Obara, Hokkaido (JP)

(73) Assignees: NEC Corporation, Tokyo (JP); NATIONAL UNIVERSITY CORPORATION HOKKAIDO UNIVERSITY, Sapporo-shi (JP)

(21) Appl. No.: 19/018,155

(22) Filed: Jan. 13, 2025

(30) Foreign Application Priority Data
Feb. 2, 2024 (JP) 2024-014519

(51) Int. Cl. G06F 9/448; G06F 40/289; G06F 40/40

(52) U.S. Cl. CPC G06F 9/4494; G06F 40/289; G06F 40/40

(57) ABSTRACT

To provide an information processing system and the like that learn in such a way as to effectively improve performance of an agent for a task requiring a plurality of steps. An information processing system according to the present disclosure includes: an agent configured to output a sequence of a plurality of actions including an action of outputting a command to an external tool in response to a user query; a feedback acquisition unit configured to acquire final feedback on the output sequence of the plurality of actions; and a parameter update unit configured to update a parameter of a model of the agent by using the feedback.

### INCORPORATION BY REFERENCE

This application is based upon and claims the benefit of priority from Japanese patent application No. 2024-014519, filed on Feb. 2, 2024, the disclosure of which is incorporated herein in its entirety by reference.

### TECHNICAL FIELD

The present disclosure relates to an information processing system, an information processing method, and a program.

### BACKGROUND ART

In recent years, training and application of tool-using agents using a language model are expanding. These agents aim to solve a complex task that cannot be solved by the language model alone or a task that requires some kind of intervention in an outside world. In a conventional method, a method (for example, FireAct) of using distillation learning from a behavior history of a teacher agent (for example, GPT-4) and a method (for example, LATS) of using feedback in a text format and changing a behavior of an agent are mainly used.

[Non-Patent Literature 1] Chen, Baian, et al. “Fireact: Toward language agent fine-tuning.” arXiv preprint arXiv: 2310.05915 (2023)

[Non-Patent Literature 2] Zhou, Andy, et al. “Language agent tree search unifies reasoning acting and planning in language models.” arXiv preprint arXiv: 2310.04406 (2023)

[Non-Patent Literature 3] Petrov, Aleksandar, Philip H S Torr, and Adel Bibi. “When Do Prompting and Prefix-Tuning Work? A Theory of Capabilities and Limitations.” arXiv preprint arXiv: 2310. 19698 (2023)

[Non-Patent Literature 4] Qiao, Shuofei, et al. “Making Language Models Better Tool Learners with Execution Feedback.” arXiv preprint arXiv: 2305.13068 (2023)

### SUMMARY

However, the method of performing distillation learning from the behavior history of the teacher agent may degrade performance because of an error in a high-performance teacher agent, or because the behavior history of the teacher agent may become training data that ignore presence of a performance difference (e.g., an amount of knowledge) between a learner agent and the teacher agent. Further, the method of changing the behavior of the agent by using feedback in a text format described in Non-Patent Literature 2) has a problem that, as described in Non-Patent Literature 3, the feedback in the text format is inferior in ability of changing a behavior of an language model as compared with a method of updating a parameter of an agent model.

In addition, in TRICE described in Non-Patent Literature 4, in order to solve these problems, a method is adopted in which, after performing distillation learning from a behavior history of a teacher agent, a parameter of a learner agent is updated by using an action of the learner agent and feedback thereto from the outside world, and performance is further improved.

The above-described technology TRICE mainly assumes a task to be completed in one step, and only feedback associated with only one action of the agent is accepted. However, in practice, there are many complicated tasks that require a plurality of steps, and suitable learning for a plurality of actions of an agent that performs such complicated tasks is desired.

The present disclosure has been made in order to solve at least some of such problems, and an example object of the present disclosure is to provide an information processing apparatus and the like that learn in such a way as to effectively improve performance of an agent for a task requiring a plurality of steps.

In a first example aspect, an information processing system according to the present disclosure includes: an agent configured to output a sequence of a plurality of actions including an action of outputting a command to an external tool in response to a user query; a feedback acquisition unit configured to acquire final feedback on the output sequence of the plurality of actions; and a parameter update unit configured to update a parameter of a model of the agent by using the final feedback.

In a second example aspect, a computer-executed information processing method according to the present disclosure includes: outputting, by an agent, a sequence of a plurality of actions including an action of outputting a command to an external tool in response to a user query; acquiring final feedback for the output sequence of the plurality of actions; and updating a parameter of a model of the agent by using the final feedback.

In a third example aspect, a program according to the present disclosure causes a computer to execute: processing of outputting, by an agent, a sequence of a plurality of actions including an action of outputting a command to an external tool in response to a user query; processing of acquiring final feedback on the output sequence of the plurality of actions; and processing of updating a parameter of a model of the agent by using the final feedback.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 illustrates an agent learning system according to some example embodiments of the present disclosure;

FIG. 2 is a block diagram illustrating a configuration of an information processing system 1 according to some example embodiments of the present disclosure;

FIG. 3 is a flowchart illustrating an information processing method according to the present disclosure; and

FIG. 4 is a block diagram illustrating a configuration example of an information processing apparatus and the like according to another example embodiment of the present disclosure.

### EXAMPLE EMBODIMENT

Hereinafter, specific example embodiments to which the present disclosure is applied will be described in detail with reference to the drawings. However, the present disclosure is not limited to the following example embodiments. Further, for clarity of explanation, the following description and the drawings are simplified as appropriate.

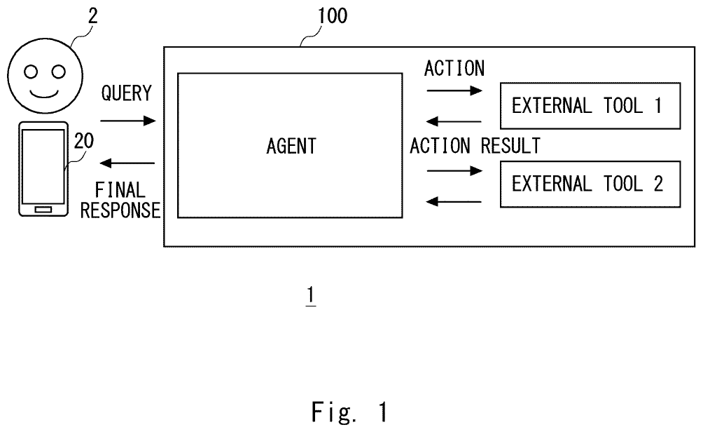

FIG. 1 illustrates an agent learning system according to some example embodiments. A use case assumed in the present example embodiment is described using a specific example. An agent model learning system according to the present example embodiment efficiently learns a model of an agent that talks with a user.

An information processing system 1 may include an information processing apparatus (server computer) 100 including an agent model and a learning function thereof, and a user terminal 20 such as a smartphone or a personal computer owned by a general user 2 that is communicably connected to the information processing apparatus 100.

A user uses a user terminal to proceed with a task composed of a plurality of utterances, such as making a travel plan and making a restaurant reservation, while interacting with an agent on a server. In particular, a task according to the present embodiment may be a complex task that cannot be solved by a language model alone and may require a result (also referred to as an action result) that is output by using an external tool (for example, a search engine, a calculator, mail software, and the like). The complex task may be, for example, a task that requires newer knowledge than when the language model is trained, or a task that requires intervention outside the language model. The agent asks or suggests the user in a conversation. The user transmits a simple evaluation such as “good”, “bad”, or the like from a smartphone for each utterance of the agent. Simple evaluation data such as “Good”, “Bad”, and the like may be converted into numerical data. A learning apparatus on the server uses these evaluations to update a parameter of an agent model and enhances conversational ability.

In addition, the user evaluates a content of the agent's utterance itself at a halfway stage of the task and also generates intermediate feedback. As a result, it is possible to efficiently improve the conversational ability of the agent even for a task that involves a plurality of utterances. In this way, it is possible to create a high-performance language model agent for a task of solving a problem by using an external tool such as robotic process automation (RPA) multiple times.

As described above, the present example embodiment is a system that achieves effective learning of an agent model by maximally utilizing feedback acquired from an actual conversation with a user.

### Configuration of Information Processing System

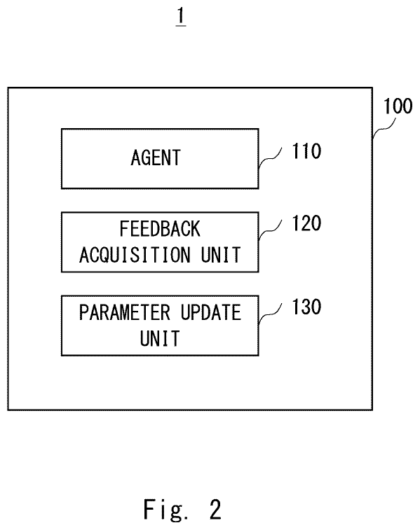

A configuration of the information processing system 1 according to the present example embodiment is described with reference to FIG. 2. FIG. 2 is a block diagram illustrating a configuration of the information processing system 1 according to some example embodiments.

The information processing system 1 includes one or more information processing apparatuses 100. The information processing apparatus 100 may be, for example, an information processing apparatus such as a server computer. As illustrated in FIG. 2, the information processing apparatus 100 includes an agent 110, a feedback acquisition unit 120, and a parameter update unit 130.

The information processing system 1 may include a plurality of information processing apparatuses. For example, the information processing system 1 may include an information processing apparatus 100 including the agent 110 (agent model), a user terminal including the feedback acquisition unit 120, and a learning apparatus including the parameter update unit 130. In other words, each component of the information processing apparatus 100 may be distributed by a plurality of computers communicably connected to each other.

The agent 110 generates a character string in response to a user query and thereby outputs a sequence of a plurality of actions including an action of outputting a command (specifically, a character string representing a usage method of an external tool) to an external tool. The agent 110 uses an untrained agent model (i.e., a language model) to directly answer a given task (problem) and output a string of a plurality of actions. The agent model (i.e., the language model used in the present description) is not limited to a traditional language model that handles only character information, and may include, for example, a model that generates an image, audio data, or the like and presents the image or the audio data to a user.

The language model used in the present description is a model that has learned relationships between words in a sentence, and generates, from a target character string, a relevant character string associated with the target character string. By using a language model that has been trained with sentences and texts in various contexts, it is possible to generate a relevant character string with a reasonable content related to a target character string.

For example, a case where a language model is used in question answering is described. The language model accepts an input of a question “What country is Japan?” as a target character string. The language model generates a character string such as “Japan is an island country in the northern hemisphere . . . ” as an answer to the question.

A learning method of the language model is not particularly limited, but the language model may be, for example, trained in such a way as to output at least one sentence including an input character string.

Specific examples of the language model include a generative pre-trained transformer (GPT) that outputs a sentence including an input character string by predicting a character string having a higher probability of following the input character string. In addition, for example, a text-to-text transfer transformer (T5), bidirectional encoder representations from transformers (BERT), robustly optimized BERT approach (RoBERTa), efficiently learning an encoder that classifies token replacements accurately (ELECTRA), or the like is also the language model.

Further, the character string generated by the language model is not limited to a natural language. For example, the language model may output an artificial language (a program source code or the like) to a character string input in a natural language. For example, the language model accepts an input of a question “How do I retrieve data including a specific character string from a database?” as a target character string. The language model may output a program source code for performing database processing. Alternatively, the language model may output a natural language associated with a character string input in an artificial language.

In addition, the language model may be input with image data, moving image data, audio data, or data in other data formats.

Further, a content generated by the language model is not limited to a character string. The language model may, for example, generate image data, video data, audio data, or data in other data formats associated with the input character string.

An action of the agent 110 is a response (e.g., including a response to a user, a command output for use of the external tool) from the agent model at each step. The sequence of the plurality of actions is a series of actions output in response to the user query, and is all of the plurality of actions of the agent 110 until the task is completed (in FIG. 1, until a final response is acquired), regardless of whether the task for the user query is succeeded or not. The task according to the present example embodiment may be a task that requires newer knowledge than when the language model is trained, or a task that requires intervention outside the language model. Therefore, the sequence of the plurality of actions that solves the task includes at least one action of outputting a command representing a usage method of the external tool. The sequence of the plurality of actions may include a first action of outputting a command representing a usage method of the external tool, and a second action based on an action result acquired from the external tool due to the output of the first action. Note that the sequence of the plurality of action columns may include one or more other actions before the first action or after the second action.

The external tool herein is a tool that is external to the agent model, and is a tool that can be operated by a command output from the agent 110. The external tool may be, for example, application software installed in advance in the information processing apparatus 100. Examples of application software that may be the external tool include, but are not limited to, a browser, a search engine, mail software, a calculator, a control program for a built-in camera, and the like.

The agent 110 may store a behavior history including a plurality of actions and action results (specifically, responses from the external tool) in a storage unit of the information processing system 1.

The feedback acquisition unit 120 acquires feedback for the sequence of the plurality of actions of the agent 110. In the present description, feedback received after task completion may also be referred to as final feedback (as opposed to intermediate feedback described below). The feedback acquisition unit 120 may acquire a behavior history of the agent 110 and data of evaluation by the user for the behavior history. A behavior history is a sequence of actions of one or more agents. The data of evaluation by the user may be directly given to the information processing apparatus 100 by a person who is the user. Alternatively, data mechanically generated by arithmetic processing inside the information processing apparatus 100 may be used as the evaluation data. The feedback acquisition unit 120 acquires feedback when the task is completed. A more detailed method of receiving feedback is described later.

The parameter update unit 130 updates a parameter of the agent model of the agent 110 using the acquired feedback. The parameter update unit 130 updates the parameter of the agent model using the behavior history and the data of evaluation by the user acquired by the feedback acquisition unit. A more detailed method of updating the parameter is described later.

### Specific Example 1 of Feedback Reception Method and Update Method

The parameter update unit 130 updates a parameter of the agent model by using the feedback by the user on the behavior history over a plurality of steps. In this process, a plurality of previous actions by the agent 110 and feedback on the previous actions are taken into account. The feedback is information indicating how much the action of the agent 110 contributes to achievement of a task goal.

As an example, a case where a decoder-type language model is used as an agent model. The decoder-type language model is a model that recursively generates a sentence following a given sentence. The agent model represents, for example, an input from a user, a response from an external tool, and an action of the agent 110 as sentences, and inputs a sentence acquired by arranging the sentences in chronological order and combining them, into the model. In response, the agent model outputs an action in a next step, as a subsequent sentence.

Based on final feedback acquired at an end of the task, a probability that an output by the agent 110 (e.g., a portion of the generated sentence) at each step occurs is adjusted. This adjustment of the probability allows the agent 110 to learn more effective behaviors.

As a specific example, a case where the user inputs “Make an appointment at an internal medicine clinic in Tokyo” into the agent model of the information processing apparatus 100 is considered. In a first step, a character string A “Make an appointment at an internal medicine clinic in Tokyo” being an input from the user, is input to the agent model, and the agent model outputs a command being a character string B “Web_Search (“Tokyo Internal Medicine”)” as an action. Then, by executing this command, a character string C “Tanaka Internal Medicine Clinic Address: Tokyo E-mail: tanaka@sample” being a response is acquired from an external tool (e.g., a search engine).

In a next step, a character string D combining the character strings A, B, and C is input to the agent model, and the agent model outputs a character string E “Send_Mail (“tanaka@sample”, “I would like to make an appointment”)” as an action (i.e., sends an e-mail). After these steps are completed, the feedback acquisition unit 120 acquires final feedback according to a degree of success of the task as evaluation data.

Specifically, the feedback can be represented by, for example, a numerical value of 0 or more and 1 or less. In this case, for example, the closer the feedback is to 1, the more likely the task is succeeded, and the closer the feedback is to 0, the more likely the task is failed. Any number of values equal to or more than 0 and equal to or less than 1 may be defined as a threshold value. In this case, the information processing apparatus 100 may determine whether the task is succeeded or failed, based on whether the feedback exceeds the threshold value. As described above, in the present example embodiment, since the feedback can be acquired as a numerical value, a parameter can be updated in such a way as to change a behavior of the language model more appropriately as compared with a case in which feedback in a text format is used.

The feedback may be acquired directly from the user via a user interface. For example, the information processing apparatus 100 may cause the user interface to display degrees of success of the task, and to select a degree of success by an operation by the user. Alternatively, the information processing apparatus 100 may acquire the degree of success of the task by estimating the degree of success of the task from a face image of the user captured by a camera. Further, the information processing apparatus 100 may acquire the degree of success of the task by estimating the degree of success of the task from voice data of the user picked up by a microphone. In other example embodiments, the information processing apparatus 100 may use data mechanically generated by some kind of arithmetic processing as the evaluation data.

Next, the parameter update unit 130 updates a parameter of the agent model using an acquired behavior history and the evaluation data. For this purpose, the parameter update unit 130 acquires pairs of an input to and an output from the agent model in each step, specifically, [the character string A, the character string B] and [the character string D, the character string E], from the behavior history. Then, the parameter update unit 130 adjusts, based on the evaluation data, a probability that the associated output is output by the agent model in response to the input in these input/output pairs. For example, when the evaluation data is larger than the certain threshold value (the task is succeeded), the parameter of the agent model is updated using a gradient method or the like in such a way that a probability that the character string B is output in response to the character string A and the character string E is output in response to the character string D is increased.

### Example 2 of Feedback Reception Method and Update Method

In addition to final feedback for an entire behavior history, the feedback acquisition unit 120 may also acquire intermediate feedback for some actions included in the behavior history.

For example, in the case of the above-described specific example, in addition to the above-described final feedback according to the degree of success of the task, for example, a degree of desirability of generating the character string B for the action in step 1, specifically, in response to the character string A may be given as feedback. In this case, in addition to the final feedback according to the degree of success of the task in the specific example 1, the feedback acquisition unit 120 also acquires, as the evaluation data, intermediate feedback on the desirability of the action in the first step described above.

In this case, the parameter update unit 130 performs parameter updating in consideration of intermediate feedback on some actions, in addition to the parameter updating in the specific example 1. For example, in the above-described case, when the degree of desirability of the action in step 1 is larger than a certain threshold value (that is, a probability that the action is desirable is high), a parameter of the agent model is updated using a gradient method or the like in such a way that a probability that the character string B is generated in response to the character string A is high.

By performing the parameter updating using such intermediate feedback, the following improvement in learning efficiency can be achieved. For example, it is desirable for task achievement to output the string B in response to the string A in the first step. However, even in a case where the task is ultimately not achieved due to a failure in a step later than the first step, a parameter update can be performed in such a way to facilitate the action in the first step. In other words, by using the intermediate feedback, a parameter for an intermediate action can be optimized for ultimate task achievement even when performance of the agent 110 is low and a probability that the task is ultimately achieved is low.

### Intermediate Feedback Generation Method 1

Although the situation in which the intermediate feedback is provided from an outside (for example, from the user) has been described in the above-described specific example 2, the intermediate feedback may be generated inside the feedback acquisition unit 120. For example, an evaluation model that outputs a score of how desirable an action to be evaluated is for task resolution may be used. In the above-described case, a character string acquired by combining the user input character string A being a purpose of the task, the character string B being the action by the agent model in response to the character string A, and an instruction sentence that instructs to evaluate desirability of the action by the agent model and to output a result of the evaluation as a numerical value is input to a pre-trained language model. Then, a numerical value converted from an output character string acquired from the pre-trained language model can be used as the intermediate feedback on the action in step 1.

### Intermediate Feedback Generation Method 2

As another specific example of generating the intermediate feedback inside the feedback acquisition unit 120, a method is described that estimates, by using final feedback on the entire behavior history acquired after the task is completed, how desirable a state at a certain point in the behavior history is for task completion. The state at a certain point in the behavior history is, for example, a state at a point when the first step is completed in the specific example described above. Specifically, the state at a certain point in the behavior history can be a state S1 in which the agent 110 outputs the character string B that is a command character string in response to the character string A that is a user query, and the character string C is acquired as information about the Tanaka internal medicine clinic as a response from the external tool.

In order to estimate how desirable the state S1 is for solution of the task “Make an appointment at an internal medicine clinic in Tokyo”, behavior histories of various different agents and results thereof are sampled from the above-described state using a tree search method such as Monte-Carlo tree search, for example. For more information, see Non-Patent Literature 2: Zhou, Andy, et al. “Language agent tree search unifies reasoning acting and planning in language models.” arXiv preprint arXiv: 2310.04406 (2023).

Then, the feedback acquisition unit 120 acquires feedback indicating a degree of success of a task in the above-described method with respect to the sampled behavior histories and the results. Subsequently, the feedback acquisition unit 120 can calculate an average of the feedback as a value of the state S1, based on the acquired feedback. For example, in a case where a sample succeeds 700 times out of 1000 times, a 70% probability of success (i.e., a state value of 0.7) can be acquired. Then, the feedback acquisition unit 120 can acquire the value of the state SI described above as intermediate feedback on the action in the first step, specifically, on outputting the character string B in response to the character string A.

### Flow of Information Processing Method

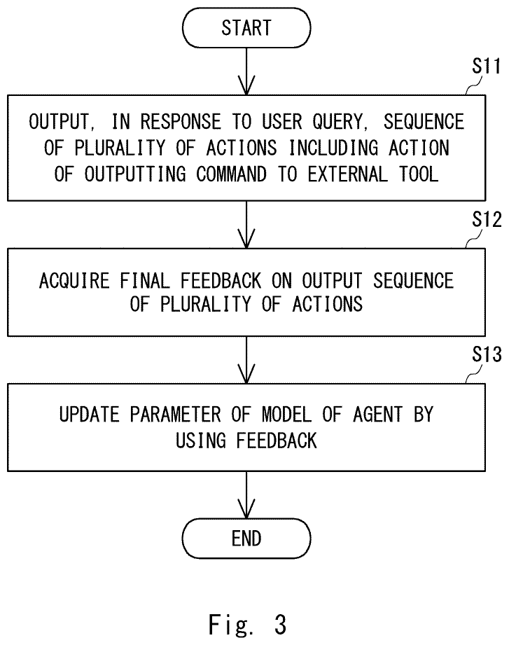

FIG. 3 is a flowchart illustrating an information processing method according to the present disclosure.

The information processing method is executed by a computer. Specifically,

The agent 110 outputs a sequence of a plurality of actions including an action of outputting a command to an external tool in response to a user query (S11). The feedback acquisition unit 120 acquires final feedback on the output sequence of the plurality of actions (S12). The parameter update unit 130 updates a parameter of a model of the agent 110 using the acquired feedback (S13).

Note that, the agent model can be optimized for each user by the learning process described above. Alternatively, the agent model may be optimized for each user attribute (e.g., age, gender, occupation) by the learning process described above. Further, a general-purpose agent model may be generated and an attribute of the user may be acquired, and thereby a response suitable for the user may be acquired.

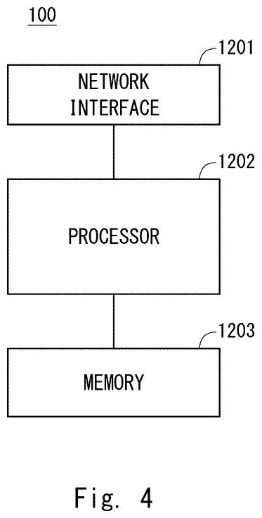

FIG. 4 is a block diagram illustrating a configuration example of the information processing apparatus 100. Referring to FIG. 4, the information processing apparatus 100 includes a network interface 1201, a processor 1202, and a memory 1203. The network interface 1201 is used for communicating with other network node apparatuses configuring a communication system. The network interface 1201 may be used for performing wireless communication. For example, the network interface 1201 may be used for performing wireless-LAN communication as specified in IEEE802.11 series or mobile communication as specified in 3rd generation partnership project (3GPP) (registered trademark). Alternatively, the network interface 1201 may include a network interface card (NIC) compliant with IEEE 802.3 series, for example.

The processor 1202 reads and executes software (computer program) from the memory 1203, thereby performing processing of the information processing apparatus 100 described using the flowchart or the sequence in the above-described example embodiment. As the processor 1202, for example, a central processing unit (CPU), a graphic processing unit (GPU), a digital signal processor (DSP), a micro processing unit (MPU), a floating point number processing unit (FPU), a physics processing unit (PPU), a TensorProcessingUnit (TPU), a quantum processor, a microcontroller, or a combination thereof can be used.

The memory 1203 is configured of a combination of a volatile memory and a non-volatile memory. The memory 1203 may include a storage disposed distant from the processor 1202. In this case, the processor 1202 may access the memory 1203 via an unillustrated I/O interface.

In the example in FIG. 4, the memory 1203 is used to store software modules. The processor 1202 reads these software modules from the memory 1203 and executes the software modules, and can thereby perform the processing of the information processing apparatus 100 described in the above-described example embodiment.

As described with reference to FIG. 4, each processor 1202 included in the information processing apparatus 100 executes one or more programs including a group of instructions for causing a computer to perform the algorithm described with reference to the drawing.

Although the present disclosure has been described with reference to the example embodiments, the present disclosure is not limited to the above-described embodiments. Various changes that can be understood by a person skilled in the art within the scope of the present disclosure can be made to the configuration and details of the present disclosure. Each example embodiment can be combined with other embodiments as appropriate.

The drawings are merely examples for describing one or more example embodiments. Each drawing may be associated with one or more other example embodiments, rather than only one particular example embodiment. As understood by those skilled in the art, various features or steps described with reference to any one of the drawings may be combined with features or steps illustrated in one or more other drawings, for example, in order to create an example embodiment that is not explicitly illustrated or described. The features or steps illustrated in any one of the drawings in order to describe the example embodiments are not necessarily all essential, and some features or steps may be omitted. An order of the steps described in any of the drawings may be changed as appropriate.

In the examples described above, the program includes instructions (or software code) that, when loaded into a computer, cause the computer to perform one or more of the functions described in the embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

An example advantage according to the present disclosure is that it is possible to provide an information processing system and the like that learn in such a way as to effectively improve performance of an agent for a task requiring a plurality of steps.

A part or the entirety of the above-described embodiment may be described as the following supplementary notes, but are not limited thereto.

### Supplementary Note 1

An information processing system including:
an agent configured to output a sequence of a plurality of actions including an action of outputting a command to an external tool in response to a user query;
a feedback acquisition unit configured to acquire final feedback on the output sequence of the plurality of actions; and
a parameter update unit configured to update a parameter of a model of the agent by using the final feedback.

### Supplementary Note 2

The information processing system according to supplementary note 1,wherein the sequence of the plurality of actions include a first action of outputting a command representing a usage method of the external tool, and a second action based on an action result acquired from the external tool as a result of outputting the first action.

### Supplementary Note 3

The information processing system according to supplementary note 1 or 2, further including:
a feedback acquisition unit configured to acquire final feedback on the output sequence of the plurality of actions and intermediate feedback on some actions of the sequence of the plurality of actions, the final feedback and the intermediate feedback being numerical feedback; and
a parameter update unit configured to update a parameter of a model of the agent by using the final feedback and the intermediate feedback.

### Supplementary Note 4

The information processing system according to any one of supplementary notes 1 to 3, wherein the intermediate feedback is generated by using an evaluation model of outputting a score of how desirable an action to be evaluated is for task resolution.

### Supplementary Note 5

The information processing system according to any one of supplementary notes 1 to 4, wherein a character string acquired by combining a user input first character string being a purpose of a task, a second character string being an action of an agent model in response to the first character string, and an instruction sentence that instructs to evaluate, based on the first character string and the second character string, desirability of the action of the agent model, and to output an evaluation result as a numerical value is input into a pre-trained language model, and an acquired output character string converted into a numerical value is used as intermediate feedback on a first action.

### Supplementary Note 6

The information processing system according to supplementary note 3, wherein the intermediate feedback is generated by a tree search method of estimating a degree of desirability of a state value at a certain time point in the sequence of the plurality of actions for task completion, by using final feedback on the entire sequence of the plurality of actions to be acquired after task completion.

### Supplementary Note 7

The information processing system according to any one of supplementary notes 1 to 6, wherein the external tool is external to the agent model and is a software program installed in advance in an information processing apparatus.

### Supplementary Note 8

The information processing system according to supplementary note 3, wherein the final feedback and the intermediate feedback are acquired from a user via a user interface and converted into numerical feedback.

### Supplementary Note 9

A computer-executed information processing method including:
outputting, by an agent, a sequence of a plurality of actions including an action of outputting a command to an external tool in response to a user query;
acquiring final feedback on the output sequence of the plurality of actions; and
updating a parameter of a model of the agent by using the final feedback.

### Supplementary Note 10

A program causing a computer to execute:
processing of outputting, by an agent, a sequence of a plurality of actions including an action of outputting a command to an external tool in response to a user query;
processing of acquiring final feedback on the output sequence of the plurality of actions; and
processing of updating a parameter of a model of the agent by using the final feedback.

Some or all of the elements (e.g., configurations and functions) described in supplementary notes 2 to 8 depending on supplementary note 1 may be also dependent on supplementary notes 9 and 10 by the same dependencies as Appendices 2 to 8. Some or all of the elements described in any supplementary note may be applied to various hardware, software, and recording means, a system, and a method for recording the software.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing system comprising:
at least one memory storing instructions; and
at least one processor configured to execute the instructions to,
output, via an agent, a sequence of a plurality of actions including an action of outputting a command to an external tool in response to a user query,
acquire final feedback on the output sequence of the plurality of actions, and
update a parameter of a model of the agent by using the final feedback.

2. The information processing system according to claim 1, wherein the sequence of the plurality of actions includes:
a first action of outputting a command representing a usage method of the external tool; and
a second action based on an action result acquired from the external tool as a result of outputting the first action.

3. The information processing system according to claim 1, wherein the at least one processor is configured to execute the instructions to
acquire final feedback on the output sequence of the plurality of actions and intermediate feedback on some actions of the sequence of the plurality of actions, the final feedback and the intermediate feedback being numerical feedback, and
update a parameter of a model of the agent by using the final feedback and the intermediate feedback.

4. The information processing system according to claim 3, wherein the intermediate feedback is generated by using an evaluation model of outputting a score of how desirable an action to be evaluated is for task resolution.

5. The information processing system according to claim 1, wherein a character string acquired by combining a user input first character string being a purpose of a task, a second character string being an action of an agent model in response to the first character string, and an instruction sentence that instructs to evaluate, based on the first character string and the second character string, desirability of the action of the agent model, and to output an evaluation result as a numerical value is input into a pre-trained language model, and an acquired output character string converted into a numerical value is used as intermediate feedback on a first action.

6. The information processing system according to claim 3, wherein the intermediate feedback is generated by a tree search method of estimating how desirable a state value at a certain time point in the sequence of the plurality of actions is for task completion, by using final feedback on the entire sequence of the plurality of actions to be acquired after task completion.

7. The information processing system according to claim 1, wherein the external tool is external to the agent model and is a software program installed in advance in an information processing apparatus.

8. The information processing system according to claim 3, wherein the final feedback and the intermediate feedback are acquired in a text format from a user via a user interface and converted into numerical feedback.

9. A computer-executed information processing method comprising:
outputting, by an agent, a sequence of a plurality of actions including an action of outputting a command to an external tool in response to a user query;
acquiring final feedback on the output sequence of the plurality of actions; and
updating a parameter of a model of the agent by using the final feedback.

10. A non-transitory computer-readable medium storing a program causing a computer to execute:
processing of outputting, by an agent, a sequence of a plurality of actions including an action of outputting a command to an external tool in response to a user query;
processing of acquiring final feedback on the output sequence of the plurality of actions; and
processing of updating a parameter of a model of the agent by using the final feedback.
